(19) United States
(12) Patent Application Publication
(10) Pub. No.: US 2024/0217615 A1
(43) Pub. Date: Jul. 4, 2024

(54) BICYCLE BRAKING SYSTEM

(71) Applicant: Leif Harnden, Redlands, CA (US)

(72) Inventor: Leif Harnden, Redlands, CA (US)

(21) Appl. No.: 18/092,199

(22) Filed: Dec. 30, 2022

(51) Int. Cl. B62L 1/14; B62L 1/00

(52) U.S. Cl. CPC B62L 1/14; B62L 1/005; B62L 3/02

(57) ABSTRACT

A bicycle braking system, installed on a bicycle is presented. The bicycle braking system provides improved braking for a bicycle. The system uses modified tire rims and a conventional tire, a caliper brake assembly and brake pads to provide for enhanced braking ability of the bicycle, increased life expectancy of said components, and ease of maintenance when compared to similar conventional bicycle braking systems. Other components of a standard braking system, including but not limited to brake levers and brake cables, for example Bowden cables, remain of a standard design Finally, it is noted that the system 10 would preferably be provided on all tire rims of the bicycle.

### FIELD OF THE INVENTION

This invention relates to bicycles. In particular, this invention relates to a braking system for a bicycle.

### BACKGROUND

A bicycle braking system consists of a mounting apparatus as well as brake pads installed as part of the apparatus. There are multiple styles of mountings as well as multiple types of brake pads.

Brake pads are available with numerous shapes and materials. Many consist of a replaceable rubber pad held on a mounting, or brake shoe, with a post or bolt on the back to attach to the brake. Some are made as one piece with the attachment directly molded in the pad for lower production costs; brake pads of the cartridge type are held in place by a metal split pin or threaded grub screw and can be replaced without moving the brake shoe from its alignment to the rim. The rubber can be softer for more braking force with less lever effort, or harder for longer life. Many pad designs have a rectangular shape; others are longer and curved to match the radius of the rim. Larger pads do not necessarily provide more braking force but will wear more slowly (in relation to thickness), so can usually be thinner. In general, a brake can be fitted with a variety of pads, as long as the mounting is compatible. Carbon fiber rims may be more sensitive to damage by incorrectly-matched brake pads, and generally must use non-abrasive cork pads.

Ceramic-coated rims should be used with special pads because of heat build-up at the pad-rim interface; standard pads can leave a “glaze” on the ceramic braking surface, reducing its inherent roughness and leading to a severe drop in wet-weather braking performance. Ceramic pads usually contain chromium compounds to resist heat. For wet-weather use, brake pads containing iron (iii) oxide are sometimes used as these have higher friction on a wet aluminum rim than the usual rubber. To minimize excessive rim wear, a brake pad should be hard enough that it does not embed road grit or chips of rim metal in the face of the pad, since these act as grinding/gouging agents and markedly reduce rim life.

One type of brake is called a caliper brake. The caliper brake is a class of cable-actuated brake in which the brake mounts to a single point above the wheel, theoretically allowing the arms to auto-center on the rim. Arms extend around the tire and end in brake shoes that press against the rim. While some designs incorporate dual pivot points—the arms pivot on a sub-frame—the entire assembly still mounts to a single point. Caliper brakes tend to become less effective as tires get wider, and so deeper, reducing the brakes' mechanical advantage. There are different types of caliper braking systems: Single pivot side-pull caliper brakes, dual-pivot caliper brakes, as well as center-pull caliper brakes.

“Single-pivot side-pull caliper brakes” consist of two curved arms that cross at a pivot above the wheel and hold the brake pads on opposite sides of the rim. These arms have extensions on one side, one attached to the cable, the other to the cable housing. When the brake lever is squeezed, the arms move together, and the brake pads squeeze the rim. These brakes are simple and effective for relatively narrow tires but have significant flex and resulting poor performance if the arms are made long enough to fit wide tires. If not adjusted properly, low-quality varieties tend to rotate to one side during actuation and tend to stay there, making it difficult to evenly space brake shoes away from the rim. These brakes are now used on inexpensive bikes; before the introduction of dual-pivot caliper brakes they were used on all types of road bikes.

Dual-pivot side-pull caliper brakes” are used on most modern racing bicycles. One arm pivot at the center, like a side-pull; and the other pivots at the side, like a center-pull. The cable housing attaches like that of a side-pull brake. The centering of side-pull brakes was improved with the mass-market adoption of dual-pivot side-pulls. These brakes offer a higher mechanical advantage, and result in better braking. Dual-pivot brakes are slightly heavier than conventional side-pull calipers and cannot accurately track an out-of-true rim, or a wheel that flexes from side to side in the frame during hard climbing.

Center-pull brakes have symmetrical arms and therefore center more effectively. The cable housing attaches to a fixed cable stop attached to the frame, and the inner cable bolts to a sliding piece (called a “braking delta”, “braking triangle”, or “yoke”) or a small pulley, over which runs a straddle cable connecting the two brake arms. Tension on the cable is evenly distributed to the two arms, preventing the brake from taking a “set” to one side or the other. They are more effective than side-pull brakes in long reach applications as the distance between the pivot and brake pad or cable attachment is much shorter, reducing flex. It is important that the fixed bridge holding the pivots is very stiff.

Accordingly, and in light of the foregoing, it would be desirable to have a braking system to provide improved braking ability in both wet and dry conditions independent of the type of bicycle in question to increase life expectancy of the braking components such as the brake pads, as well as ease of maintenance with an easily read indicator identifying if pads need replaced.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side view of the bicycle braking system 10, installed on a bicycle 15, according to the preferred embodiment of the present invention;

FIG. 2 is a side view of the rear caliper brake assembly 25, as used with the bicycle braking system 10, according to the preferred embodiment of the present invention;

FIG. 3 is a front view of the rear caliper brake assembly 25, as used with the bicycle braking system 10, according to the preferred embodiment of the present invention;

FIG. 4 is a sectional view of the bicycle braking system 10, as seen along a sectional line I-I, as shown in FIG. 1, according to the preferred embodiment of the present invention;

FIG. 5 is an isolated sectional view of the brake pad 30, as seen along a sectional line II-II, as shown in FIG. 3, according to the preferred embodiment of the present invention;

FIG. 6 is a sectional view of the bicycle braking system 10, as seen along a sectional line IV-IV, as shown in FIG. 3, according to the preferred embodiment of the present invention;

FIG. 7 is a sectional view of the bicycle braking system 10, as seen along a sectional line V-V, as shown in FIG. 2, with the brake pad 30 inserted in the brake pad holder 67, according to the preferred embodiment of the present invention; and,

FIG. 8 is a close-up perspective view of the bicycle braking system 10, according to the preferred embodiment of the present invention, as shown in FIG. 1 along a sectional line III-III.

### DESCRIPTIVE KEY

10 bicycle braking system
15 bicycle
20 tire rim
25 rear caliper brake assembly
30 brake pad
35 brake lever
40 brake cable
45 caliper arm
50 brake bridge
55 main connecting bolt
60 center fixing bolt
65 mounting area
66 cut-out area
67 brake pad holder
69 pad capture groove
70 pad holder wing
75 mounting post
76 mounting post receiver
80 set screw
81 set screw receiver
82 set screw securing groove
85 travel adjuster
90 tire
95 contact area
100 internal reinforcing bridge
105 spokes
110 spoke nipple
115 friction material
120 brake pad face
125 groove
130 inspection hole
135 outer radius profile
140 inner radius profile
145 increased depth “d”
150 textured finish band
155 hub

### DESCRIPTION OF THE PREFERRED EMBODIMENTS

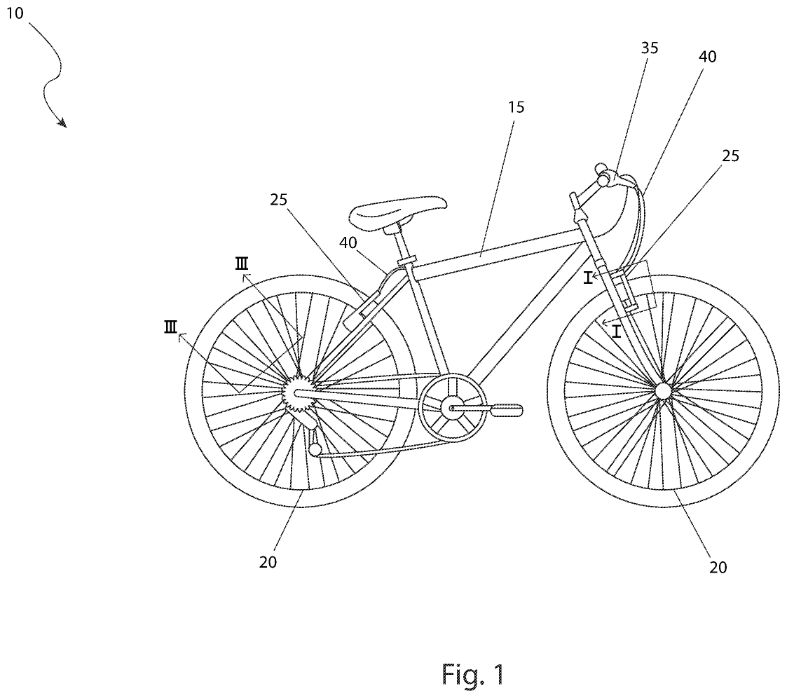

The best mode for carrying out the invention is presented in terms of its preferred embodiment, herein depicted within FIGS. 1 through 8. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

Referring now to FIG. 1, side view of the bicycle braking system 10, installed on a bicycle 15, according to the preferred embodiment of the present invention is disclosed. The bicycle braking system (herein also described as the “system”) 10, provides improved braking for a bicycle 15. The bicycle 15 may be any type, such as a road bike, a mountain bike, a touring bike, a folding bike, am electric bike, a tricycle, a fixed gear/track bike, a BMX style bike, a recumbent bike, or the like. The teachings of the system 10 being applied to an any one particular style of bicycle 15 is not intended to be a limiting factor of the present invention.

The system 10 uses modified tire rims 20 and a conventional tire 90 (not show due to illustrative limitations), a caliper brake assembly 25 and brake pads 30 (not shown due to illustrative limitations) to provide for enhanced braking ability of the bicycle 15, increased life expectancy of said components, and ease of maintenance when compared to similar conventional bicycle braking systems. Other components of a standard braking system, including but not limited to brake levers 35 and brake cables 40 (Bowden cables) remain of a standard design and as such are not covered by the claims of the present invention. It is envisioned that the bicycle braking system 10 would be provided as standard or optional equipment on new bicycle 15 or be made available as an add-on kit or replacement kit for existing bicycle 15. Further detail on the configuration and utilization of the tire rims 20, the caliper brake assembly 25 and the brake pads 30 will be provided herein below. Finally, it is noted that the system 10 would preferably be provided on all tire rims 20 of the bicycle 15. However, the use of the system 10 on only one (1), or less than all of the tire rims 20, shall not be a limiting factor of the present invention.

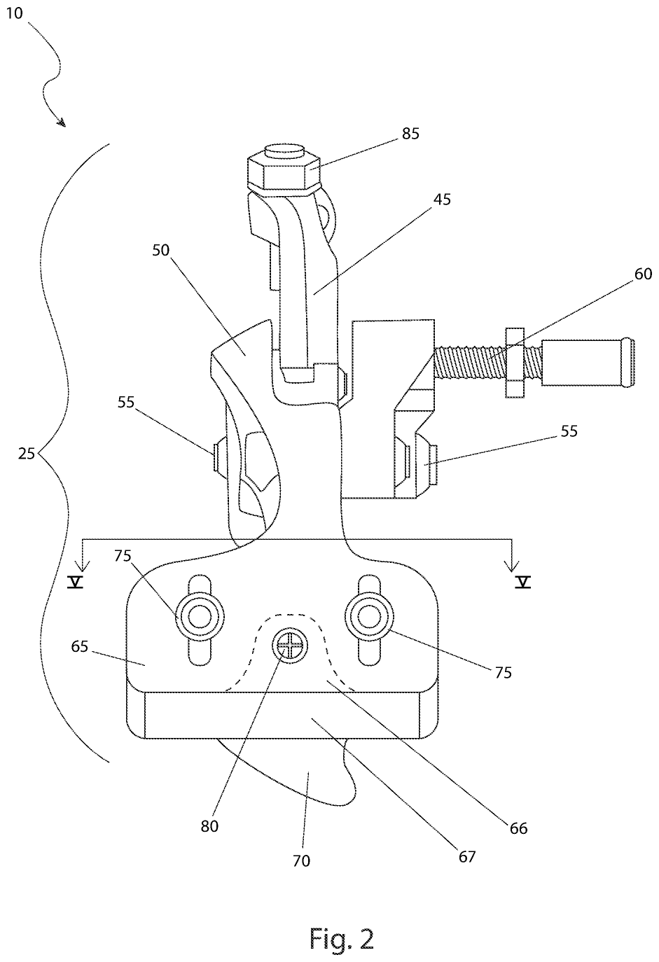

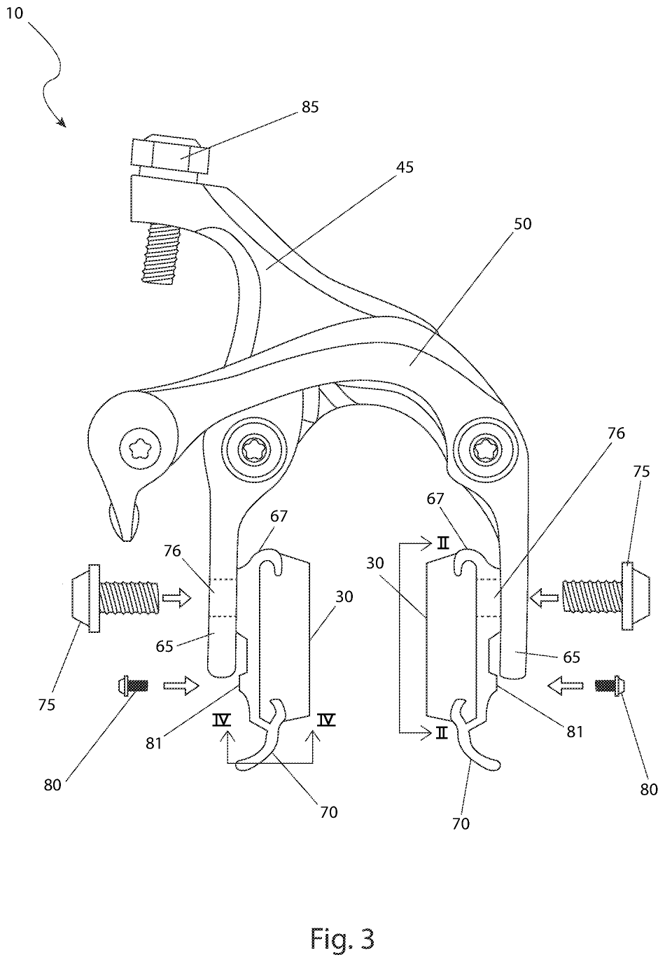

Referring next to FIG. 2, a side view of the caliper brake assembly 25, as used with the system 10, according to the preferred embodiment of the present invention is depicted. The caliper brake assembly 25 includes a caliper arm 45 connected to a brake bridge 50 via a main connecting bolt 55. The caliper brake assembly 25 will be physically attached to the bicycle 15 (as shown in FIG. 1) via the center fixing bolt 60. The brake bridge 50 is provided with a large mounting area 65 that accommodates the physical mounting of a large brake pad 30 complete with a brake pad holder 67 with a pad holder wing 70. It is noted that the caliper arm 45 is provided with a similar arrangement as will be shown in greater detail in FIG. 3. Each brake pads 30 are fitted into a brake pad holder 67 by sliding them into the pad capture groove 69 (as shown in FIG. 6). The combined brake pad 30 and brake pad holder 67 is physically attached to the mounting area 65 with the use of two (2) mounting posts 75. The mounting posts 75 (one (1) more each than a conventional caliper brake system) assist in keeping the brake pads 30 in place under high braking stress, while also helping to dissipate heat during rapid or prolonged braking. These mounting posts 75 also increase security and handle increased torque associated with extreme braking and added safety in case one (1) mounting post 75 should become come loose. Additionally, the brake pads 30 are provided with a set screw 80 removably fastenable into the set screw receiver 81 to prevent the brake pad 30 from slipping out of the brake pad holder 67 if the wheel is rotated backward while the brake pad 30 is engaged with the tire rim 20. Finally, the caliper brake assembly 25 is provided with a travel adjuster 85 to allow adjustment of the brake cables 40 (as shown in FIG. 1) and operates in an expected manner. Alternately, a cut-out area 66 may be formed in the mounting area 65 to accommodate the passage of the set screw 80 through the brake pad holder 67, set screw receiver 81, and brake pad 30.

Referring now to FIG. 3, a front view of the caliper brake assembly 25, as used with the system 10, according to the preferred embodiment of the present invention is shown. This view provides further clarification of the configuration and operation of the caliper arm 45 and the brake bridge 50 and the two (2) each mounting area 65, the brake pads 30, the pad holder 67, and the pad holder wing 70, on each respective caliper arm 45 and the brake bridge 50. The mounting posts 75 are shown in a removed position for clarification of their attachment means to the brake pads 30. It is noted that only one (1) of two (2) mounting posts 75 are shown on each mounting area 65 due to illustrative limitations.

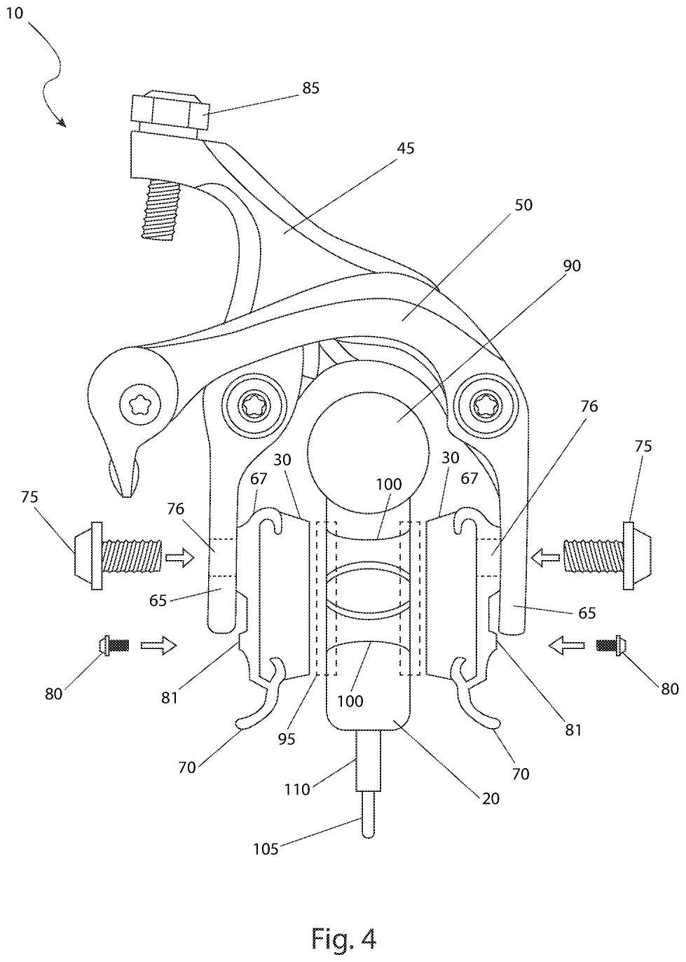

Referring next to FIG. 4, a sectional view of the system 10, as seen along a line I-I, as shown in FIG. 1, according to the preferred embodiment of the present invention is disclosed. This view provides teachings of the tire rims 20 and the tire 90. As can be seen, the contact area 95 (herein indicated by dashed lines) is much larger than would typically be expected on a conventional bicycle caliper braking system. To prevent deformation of the tire rims 20, multiple internal reinforcing bridges 100 are provided to aid in even dissipation of braking forces during maximal braking actuation. It is envisioned that the tire rims 20 would be made of aluminum or carbon fiber, depending on pricing structures. The use of any particular material of construction for the tire rims 20 are not intended to be a limiting factor of the present invention. The tire 90 is of a standard design and is attached to the tire rime 20 with conventional means. The tire rim 20 and the tire 90 are attached to the bicycle 15 (as shown in FIG. 1). The wheel, as shown in FIG. 8, is composed of a hub 155, spokes 105 and spoke nipples 110 that run between the calipers of the system 10 as would typically be expected.

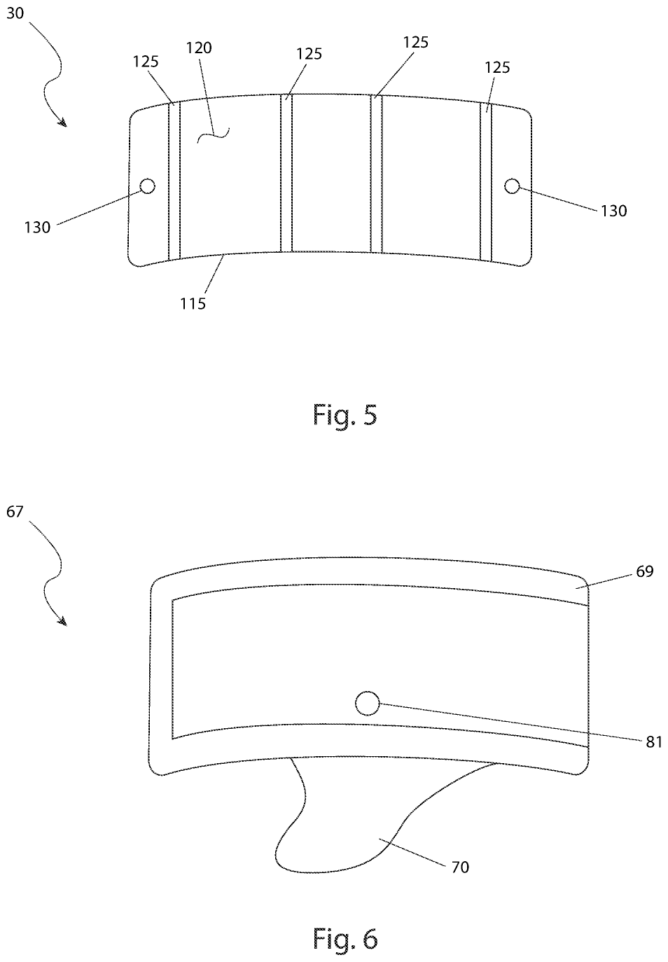

Referring now to FIG. 5, a sectional view of the system 10, as seen along a line II-II, as shown in FIG. 3, according to the preferred embodiment of the present invention is depicted. This view provides further clarification of the oversized configuration of the brake pads 30 when compared to conventional bicycle brake components. The brake pads 30 are manufactured from friction material 115 of conventional design. Each brake pad face 120 is provided with grooves 125 to assist in enhancing braking ability by provided an exit path for dirt, water, and other friction reducing contaminants caught between the brake pad face 120 and the tire rim 20 (as shown in FIGS. 1 and 4). The brake pad face 120 is provided with at least one (1) inspection hole 130 (two (2) are shown) for purposes of determining when the friction material 115 has worn down to an unacceptable limit. The user will simply look to see if the inspection holes 130 are still visible. If the inspection holes 130 are not visible, it is time to replace the existing brake pad 30 with a new brake pad. The brake pad 30 is provided with an outer radius profile 135 and an inner radius profile 140 to match the brake pad holder 67 and the tire rim 20 for maximum braking efficiency. The size of brake pad 30 may vary per specific design. However, a typical design is envisioned to be up to forty-eight millimeters (48 mm) wide, while the depth may range between eleven millimeters to one hundred ten millimeters (11-110 mm). The use of any particular size of brake pad 30 is not intended to be a limiting factor of the present invention.

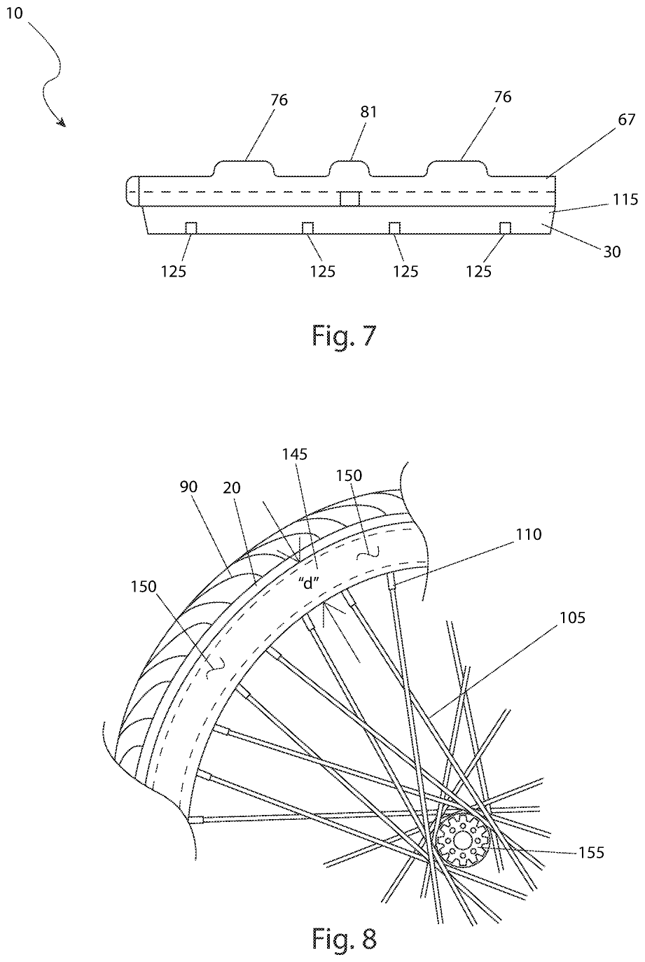

Referring now to FIG. 6, a sectional view of the bicycle braking system 10 as seen along the lines IV-IV as shown in FIG. 3. The width of the brake pad holder 67 can be seen as wider than a conventional brake pad holder. Likewise, the depth of the brake pad holder 67 can be seen as deeper than a conventional brake holder. The brake pad 30 has been omitted in this view to clearly show that the inner edges of the brake pad holder 67 form a ridge capable of capturing the brake pad 30 as shown in FIGS. 4 and 7.

Referring now to FIG. 7, a sectional view along the line V-V of FIG. 2 where the brake pad 30 is inserted into the brake pad holder 67. The mounting pasts 75 and set screw 80 and pad holder wing 70 have been omitted from this view due to illustrative limitations.

Referring finally to FIG. 8, a sectional view of the system 10, as seen along a line III-III, as shown in FIG. 1, according to the preferred embodiment of the present invention is shown. This view is a section of an entire tire rim 20 and associated tire 90 and is intended to be typical for the entire tire rim 20 and tire 90 as well as for both or all tire rims 20 and tires 90 provided on a typical bicycle 15 as shown in FIG. 1. The tire rim 20 provides for an increased depth “d” 145 when compared to a conventional tire rim. This increased depth “d” 145 provides for a textured finish band 150 that contacts the brake pad face 120 (as sown in FIG. 5) to increase friction between the tire rim 20 and the brake pads 30 for increased braking power. Finally as mentioned, the spokes 105 and the spoke nipples 110 connect the tire rim 20 to a hub 155 completing full installation of the system 10 in an expected and typical manner.

### 2. Operation of the Preferred Embodiment

The preferred embodiment of the present invention can be utilized by the common user in a simple and effortless manner with little or no training. It is envisioned that the system 10 would be constructed in general accordance with FIG. 1 through FIG. 8. The user would procure the system 10 from conventional procurement channels such as bicycle shops, sporting goods stores, discount stores, department stores, mail order and internet supply houses and the like. Special attention would be paid to the overall size of the bicycle 15 as well as the type and styling of the bicycle 15 such that it appeals to the final user.

After procurement and prior to utilization, the system 10 would be prepared in the following manner: the caliper brake assembly 25 would be installed over the tire rim 20 and the tire 90 in the expected manner. The multiple mounting posts 75 would be fastened to secure the brake pad 30 to the mounting area 65 of the caliper arm 45 and the brake bridge 50 and aligned with the set screw 80. Finally, the travel adjuster 85 would be adjusted to ensure proper clearance of the caliper brake assembly 25. At this point in time, the system 10 is ready for utilization.

During utilization of the system 10, the following procedure would be initiated: operation of the system 10 will be transparent to the user familiar with conventional bicycle braking systems. The brake levers 35 would be squeezed in a linear fashion to provide stopping power to the bicycle 15. It is envisioned that the only change anticipated in using the system 10 is when riding downhill, as less pressure would need to be applied to the brake levers 35 when compared to conventional bicycle braking systems.

The above described features are envisioned to provide the following benefits over conventional braking systems for a bicycle 15: handling improvement; increased stopping power in both wet and dry conditions; better heat dissipation due to more braking surface for the tire rim 20 and the brake pad 30 and associated lowering of operating temperature below the failure (glazing point); lengthened life cycle of the brake pad 30; ease of inspection of the brake pad 30; less force application to the brake levers 35 for an equivalent amount of braking pressure when compared to conventional braking systems along with reduced hand fatigue and an increase in safety; reduced aerodynamic drag and dead weight when compared to conventional bicycle disc braking systems; and ease of installation by reducing tolerance requirements.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A bicycle braking system for improved braking on a bicycle, the braking system comprising:
a tire rim;
a tire, the tire being configured to fit around the tire rim;
one or more brake lever, each of the brake levers being removably coupled to the tire rim;
caliber brake assembly, the caliber brake assembly being coupled to the brake levers by a first coupling device,
one or more brake pads, one of the brake pads being coupled to one of the brake levers; and
one or more brake cables, at least one of the brake cables being configured to be coupled to the caliber brake assembly and to one of the brake levers.

2. The braking system according to claim 1, wherein the bicycle is a road bike.

3. The braking system according to claim 1, wherein the bicycle is a mountain bike.

4. The braking system according to claim 1, wherein the bicycle is a touring bike.

5. The braking system according to claim 1, wherein the bicycle is an electric bike.

6. The braking system according to claim 1, wherein the bicycle is a BMX® style bike.

7. The braking system according to claim 1, wherein the braking system is configured to replace a current braking system.

8. The braking system according to claim 1, wherein the caliber brake assembly comprises:
a brake bridge; and
a caliper arm, the caliper arm connected to the brake bridge by a main connecting bolt.

9. The braking system according to claim 8, wherein the brake bridge has a large mounting area, wherein the large mounting area has a brake pad holder, the brake pad holder is configured to be coupled to one of the brake pads by a second coupling device.

10. The braking system according to claim 9, wherein the second coupling device is a pad holder wing.

11. The braking system according to claim 8, wherein the caliber brake assembly is attached to the bicycle by a center fixing bolt.

12. The braking system according to claim 8, wherein each of the brake pads are configured to be slid o into a pad capture groove of the brake pad holder.

13. The braking system according to claim 8, wherein the brake pad and the brake pad holder are configured to be coupled to the large mounting area by two (2) mounting posts.

14. The braking system according to claim 13, wherein the mounting posts are conjured to prevent the attached braking pads in place.

15. The braking system according to claim 1, wherein the caliper brake assembly has a travel adjuster, the travel adjuster is configured to adjust the brake cables.

16. The braking system according to claim 1, wherein the tire rim is larger than conventional tire rims.

17. The braking system according to claim 1, wherein the tire rims are made of an aluminum material.

18. The braking system according to claim 1, wherein the tire rims are made of an carbon fiber material.

19. The braking system according to claim 1, wherein the brake pad has a brake pad face.

20. The braking system according to claim 19, wherein the brake pad face has at least one inspection holes, the at least one inspection hole being for determining when a friction material has worn down to an unacceptable level.
